(19) United States
(12) Patent Application Publication
(10) Pub. No.: US 2016/0149793 A1
(43) Pub. Date: May 26, 2016

(54) SYSTEM FOR EVALUATING A COMPUTER NETWORK'S OPERATION CONTINUITY

(71) Applicant: COST MANAGEMENT PERFORMANCE GROUP, LLC, Cincinnati, OH (US)

(72) Inventor: Grant Allen Karnes, Cincinnati, OH (US)

(21) Appl. No.: 15/009,461

(22) Filed: Jan. 28, 2016

Related U.S. Application Data
(63) Continuation of application No. 13/973,440, filed on Aug. 22, 2013.
(60) Provisional application No. 61/691,972, filed on Aug. 22, 2012.

(51) Int. Cl. H04L 12/26; H04L 12/911

(52) U.S. Cl. CPC H04L 43/50; H04L 47/70

(57) ABSTRACT

The invention is directed to determining a readiness of a computer network to operate under adverse conditions. Once an adverse condition scenario is selected and location(s) within the computing network computing resources associated with the location(s) are determined, the system determines (i) whether a continuity operation(s), which are associated with the computing resources, is available to be triggered and (ii) whether the computing resource(s) is affected by occurrence of the at least one adverse condition scenario.

### BACKGROUND

There is a need for computer networks to able test and manage their operation continuity and disaster recovery programs with ease, on one computing platform, in less time, and using fewer resources.

### SUMMARY OF THE INVENTION

Embodiments of the invention are directed to systems, methods and computer program products for determining a computer network's readiness to operate under adverse conditions. In some embodiments, an exemplary system for determining readiness of a computing network to operate under adverse conditions includes a computing network having a plurality of networked computing resources. The system further includes a module that is stored in a memory and executable by a computing device processor. The module is configured to receive selection of at least one adverse condition scenario that may affect the computing network and determine at least one location within the computing network and at least one of the computing resources associated with the at least one location. The module is further configured to determine whether at least one continuity operation is available to be triggered. The continuity operation(s) is associated with the at least one of the computing resources. In addition, the module is configured to determine whether the at least one of the computing resource is affected by occurrence of the at least one adverse condition scenario.

In specific embodiments of the system the module is further configured to perform at least one of (i) in response to determining the at least one of the computing resources is adversely affected by occurrence of the at least one adverse scenario, initiate presentation of a first indicator on a user interface, or (ii) in response to determining the at least one of the computing resources is not adversely affected by occurrence of the at least one adverse scenario, initiate presentation of a second indicator on the user interface.

In other specific embodiments of the system, the module is further configured to initiate presentation of a matrix on the user interface, the matrix comprising (i) the at least one of the computing resources, (ii) the at least one location within the computing network, and (iii) at least one indicator indicating whether the at least one of the computing resources is adversely affected by occurrence of the at least one adverse condition scenario.

In additional specific embodiments of the system, the module is further configured to, in response to determining the at least one of the computing resources is adversely affected by occurrence of the at least one adverse condition scenario, determine whether the at least one continuity operation is triggered. The at least one triggered continuity operation is directed to at least partially restoring the at least one of the computing resources adversely affected. In such embodiments of the system, the module may be further configured to perform at least one of (i) in response to determining the at least one triggered continuity operation at least partially restores or replaces the at least one of the computing resources adversely affected, initiate presentation of a third indicator on a user interface, or (ii) in response to determining the at least one triggered continuity operation does not at least partially restore or replace the at least one of the computing resources adversely affected, initiate presentation of a fourth indicator on a user interface. In further related embodiments of the system, the module is configured to determine a vulnerability quantity of the computing network based at least partially on: a first attribute associated with the at least one of the computing resources, and a second attribute associated with the at least one continuity operation.

In still further specific embodiments of the system, the module is further configured to index the at least one continuity operation against the at least one of the computing resources and the at least one location within the computing network. The at least one continuity operation at least partially restores or replaces the at least one of the computing resources adversely affected by occurrence of the at least one adverse condition scenario. In such embodiments of the system, the at least one continuity operation may further provide for enabling access to at least one document, the at least one document comprising at least one of a recovery checklist, an asset list, an inventory list, a facility diagram, an access code, a test plan, a test result, a user list, a recovery plan, contact information, a job description, a process flow chart, or a work instruction. In further related specific embodiments of the system, the at least one continuity operation comprises multiple continuity operations. In such embodiments of the system, the module is further configured to prioritize the multiple continuity operations, wherein the prioritization is based on an order of occurrence of the multiple continuity operations.

In still further specific embodiments of the system, the module is further configured to index at least one computer network operation against the at least one of the computing resources and the at least one location within the computing network. The at least one computer network operation is adversely affected by occurrence of the at least one adverse condition scenario.

Moreover, in other specific embodiments of the system, the module is further configured to determine the readiness of the computing network to continue at least one computing network operation based at least partially on determining whether the at least one of the computing resources is affected by occurrence of the at least one adverse condition scenario. In such embodiments of the system, the at least one computing network operation is associated with the at least one of the computing resources.

In still further specific embodiments of the system, the module is further configured to assign a probability of occurrence to the at least one selected adverse condition scenario.

In additional specific embodiments of the system, the module is further configured to receive the selection of the at least one adverse condition scenario by one of (i) automatically and randomly by the module, or (ii) manually by a user of the module. In additional specific embodiments of the system, the module is further configured to receive the selection of the at least one adverse condition scenario in response to determining occurrence of the at least one adverse condition scenario.

In additional specific embodiments of the system, the at least one of the computing resources comprises multiple ones of the computing resources. In such embodiments of the system, the module is further configured to prioritize the multiple ones of the computing resources adversely affected by occurrence of the at least one adverse condition scenario. The prioritizing is based at least partially on at least one location within the computing network associated with each of the computing resources adversely affected by occurrence of the at least one adverse condition scenario.

A system for indexing within a computing network defines other embodiments of the invention. The system includes a computer network comprising a plurality of networked computing resources. The system additionally includes a module that is stored in a memory and executable by a computing device processor. The module is configured to determine at least one location within the computing network and at least one of the computing resources associated with the at least one location within the computing network. The module is further configured to index the at least one of the computing resources against the at least one location within the computing network.

In specific embodiments of such a system, the module is further configured to determine at least one computer network operation or at least one continuity operation associated with the at least one of the computing resources, and index the at least one computer network operation or at least one continuity operation against the at least one of the computing resources and the at least one location within the computing network. The at least one continuity operation at least partially restores or replaces the at least one of the computing resources when the at least one resource is at least partially adversely affected by occurrence of at least one adverse condition scenario.

### BRIEF DESCRIPTION OF THE DRAWINGS

Having thus described embodiments of the invention in general terms, reference will now be made to the accompanying drawings, where:

FIG. 1 is an exemplary user interface, in accordance with embodiments of the present invention;

FIG. 2 is an exemplary system block diagram, in accordance with embodiments of the present invention;

FIG. 3 is an exemplary module block diagram, in accordance with embodiments of the present invention;

FIG. 4 is an exemplary process flow, in accordance with embodiments of the present invention; and

FIGS. 5-7 are additional exemplary process flows, in accordance with embodiments of the present invention.

The patent or application file contains at least one drawing executed in color. Copies of this patent or patent application publication with color drawings will be provided by the Office upon request and payment of the necessary fee.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to determining or simulating adverse scenarios that affect an entity's operation, and determining which resources in which locations of the entity will be disrupted or adversely affected by the occurrence of the adverse scenarios. An exemplary method of invention comprises receiving selection of at least one adverse scenario; determining at least one location associated with the entity; determining at least one resource associated with the at least one location; determining whether at least one continuity operation is available to be triggered, wherein the at least one continuity operation is associated with the at least one resource; and determining whether the at least one resource is affected by occurrence of the at least one adverse scenario.

As used herein, an entity may refer to an organization such as a business organization. An entity may be associated with at least one resource. The at least one resource may be used to execute the processes or operations associated with the entity. The invention is not limited to any particular processes or operations. Exemplary resources include utility systems, communication systems and networks, connectivity between units of the entity over at least one network, software, hardware, data or records, physical facilities, people, etc. The types of resources are not limited to those described herein. Exemplary entity operations include any operations utilizing at least one of the entity's resources, e.g., manufacturing of goods, provision of services, payment of salaries, providing software updates, etc.

Additionally, an entity as described herein may be associated with a location. A location may be adversely affected by an occurrence of an adverse scenario described herein, and may need to be at least partially restored or recovered. In some embodiments, a location may refer to at least one of a geographical or network location associated with the entity. In some embodiments, a location may be associated with an entity unit, operation, process, resource, etc.

An entity continuity operation is an operation for continuing or restoring substantially normal operation upon occurrence of an adverse scenario, where the adverse scenario may comprise at least one of natural (e.g., disaster scenarios) or man-made activity. Examples of adverse scenarios include earthquakes, floods, fires, theft, system failure, personnel shortages, widespread illness, loss of power, loss of internet connectivity, data loss, etc. The invention is not limited to the adverse scenarios described herein. In some embodiments, an entity continuity operation described herein continues or restores only a partial portion of the normal operation upon occurrence of an adverse scenario. In some embodiments, an entity continuity operation may be an operation that at least partially or substantially restores normal operation associated with a resource. Therefore, for example, when internet connectivity associated with a particular cluster of network locations fails, a backup network system or gateway may be triggered (i.e., an entity continuity operation) that provides substantially normal internet connectivity to the affected cluster of network locations. As used herein, an entity continuity operation may also be referred to as an entity continuity plan. Therefore, as used herein, restoring normal operation associated with a resource may also comprise at least partially replacing the resource with another resource. For example, if a power system fails, a back-up power system is triggered that at least partially replaces the failed power system. As a further example, if a particular software program associated with automated performance of a function (e.g., data processing) fails, the failed software program may be at least partially replaced with manual processing of the function (e.g., manual data processing).

Additionally or alternatively, in some embodiments, the at least one continuity operation comprises enabling a system or a user of the system to access at least one document associated with the entity. In some embodiments, the at least one document comprises at least one of a recovery checklist, an asset list, an inventory list, a facility diagram, an access code, a test plan, a test result, a user list, a recovery plan, contact information, a job description, a process flow chart, or a work instruction. In some embodiments, the at least one document may enable or facilitate an entity continuity operation.

In embodiments described herein, the system described herein enables a user to create at least one adverse scenario that may possibly affect the entity (e.g., in the future). In some embodiments, the user may define the parameters of the scenario. For example, for the adverse scenario of loss of internet connectivity, the user may define a first scenario where a first set of computing systems loses full internet connectivity (e.g., computing systems associated with a first network location), and a second scenario where a different set of computing systems (e.g., computing systems associated with a second network location) loses partial internet connectivity. The user may define partial internet connectivity as the ability to access email and/or secure websites, but not the ability to access unsecure websites, or vice versa. In some embodiments, the system may present at least one preconfigured or predetermined adverse scenario option to a user, and enable the user to select the at least one adverse scenario option. In some embodiments, the system may automatically identify at least one adverse scenario that is likely to affect the entity based at least partially on at least one resource or operation associated with the entity.

In some embodiments, the system may be used to simulate the occurrence of an adverse scenario. In such embodiments, a user may transmit a selection of at least one adverse scenario to the system described herein. In response to receiving the user's selection, the system may determine whether any resources associated with any particular locations of the system are adversely affected by the selected adverse scenario. In other embodiments where the system is activated in a live setting, the system may be used to determine occurrence of an adverse scenario by determining that at least one triggering event associated with the adverse scenario has occurred. For example, if flooding occurs in a particular physical facility of the entity, the system may receive information from at least one sensor that the water level on the floor of the facility has increased to a level greater than or equal to a predetermined threshold level. In such embodiments, the system may automatically select an appropriate adverse scenario.

In some embodiments, the system enables a user to assign a probability to a scenario described herein. As used herein, the probability assigned to the scenario refers to the likelihood of occurrence of the scenario. In some embodiments, the system may automatically assign a probability to a scenario based on the resources or operations associated with the entity. For example, if the business does not have a data backup system, the system may assign a high probability to a data loss adverse scenario. As a further example, if the business operates several physical facilities that operate on fault lines, the system may assign a high probability to the adverse scenario of an earthquake occurrence.

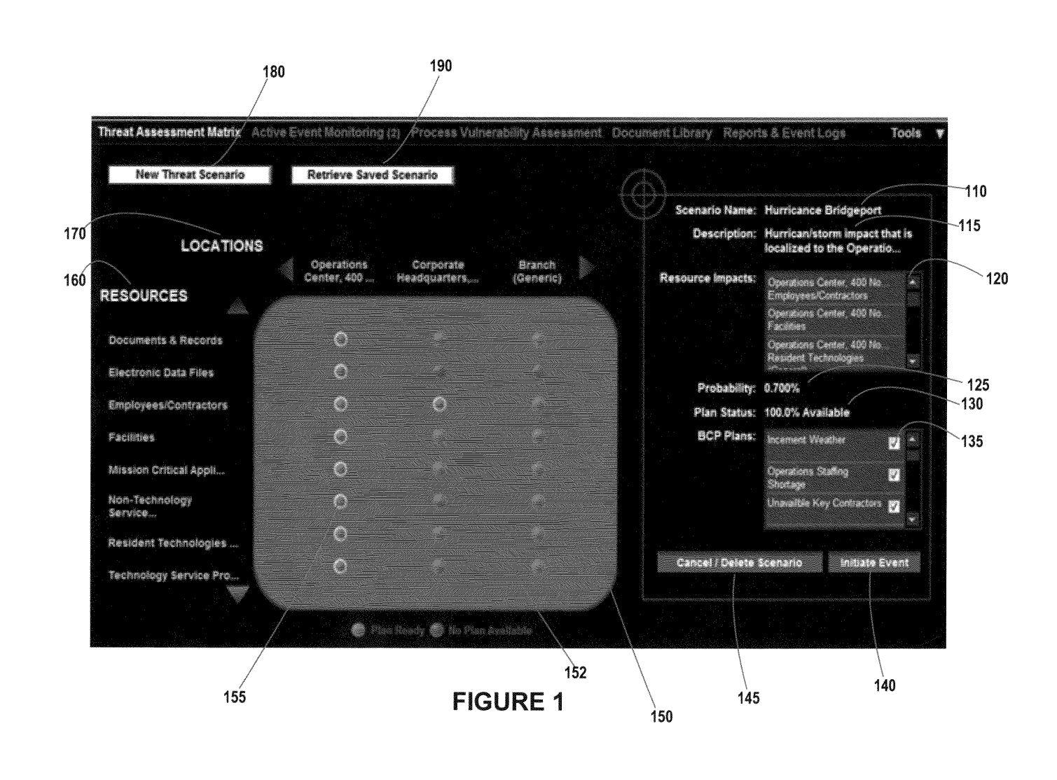

In some embodiments, the system generates and initiates presentation of a matrix of resources versus locations. The system enables a user of the system to view the list of resources associated with each location. Additionally, the system determines whether each resource is affected by occurrence of a selected adverse scenario. The adverse scenario selection may either be received from a user's computing system or may be automatically selected by the system described herein. Therefore, the matrix enables a user to view the resources of the entity that are affected by occurrence of an adverse scenario, and view the preparedness of the entity to respond to occurrence of an adverse scenario. In response to determining there is no available continuity operation associated with a resource, the system initiates presentation of a first indicator (e.g., a red-colored indicator 150 in FIG. 1). In response to determining there is at least one available continuity operation associated with a resource, the system initiates presentation of a second indicator (e.g., a green-colored indicator 152 in FIG. 1). In some embodiments, in response to determining the resource is adversely affected by occurrence of an adverse scenario, the system initiates presentation of a white ring around an indicator (e.g., the first indicator, the second indicator, etc.). In response to determining the resource is not adversely affected by occurrence of an adverse scenario, the system does not initiate presentation of the white ring around the indicator.

Therefore, for example, in response to determining there is at least one available continuity operation associated with a resource and in response to determining the resource is adversely affected by occurrence of an adverse scenario, the system initiates presentation of a third indicator (e.g., a green-colored indicator with a highlighted white ring around the green-colored indicator 155 in FIG. 1). In response to determining there is no available continuity operation associated with a resource and in response to determining the resource is adversely affected by occurrence of an adverse scenario, the system initiates presentation of a fourth indicator (e.g., a red-colored indicator with a highlighted white ring around the red-colored indicator).

Since each entity operation is associated with a resource and a location, a user can view the matrix to determine which entity operations are adversely affected by occurrence of the adverse scenario. In some embodiments, the system prioritizes the multiple resources adversely affected by occurrence of the at least one adverse scenario. For example, the system presents, on a user interface, the adversely affected resources in descending order from most adversely affected resource (e.g., 95% of normal operation of resource adversely affected) to least adversely affected resource (e.g., 15% of normal operation of resource adversely affected). Additionally or alternatively, the system prioritizes the multiple locations adversely affected by occurrence of the at least one adverse scenario. For example, the system presents the adversely affected locations in descending order from most adversely affected location (e.g., 95% of resources at affected location adversely affected at the location) to least adversely affected location (e.g., 15% of resources at affected location adversely affected at the location). The basis on which the system prioritizes the resources and/or locations is not limited to the basis described herein.

In some embodiments, the system prioritizes the entity continuity operations. For example, the system presents the entity continuity operations in descending order from most effective operation (e.g., an entity continuity operation that at least partially or fully restores 95% of adversely affected resources) to least adversely affected location (e.g., an entity continuity operation that at least partially or fully restores 15% of adversely affected resources). The basis on which the system prioritizes the operations is not limited to the basis described herein.

Additionally, for a particular location, the system determines whether the entity is ready to trigger a restoration or recovery process or operation when the system determines that a resource at that location is adversely affected by an adverse scenario. In some embodiments, prior to determining whether is ready to trigger the restoration or recovery process, the system initially determines whether a particular restoration or recovery process or operation is available, where the particular restoration or recovery process or operation at least partially restores the adversely affected resource. In some embodiments, in response to determining the at least one triggered continuity operation is available to partially restore the at least one adversely affected resource, the system initiates presentation of an indicator (e.g., a green-colored indicator) on a user interface of a user's computing device. In response to determining the at least one triggered continuity operation is not available to partially restore the at least one adversely affected resource, the system initiates presentation of an indicator (e.g., a red-colored indicator) on the user interface.

In some embodiments, at least one database may be used to store the various type of data described data described herein. For example, the at least one database (e.g., a relational database that uses relational indexing) may be used to store the various data types described herein, e.g., resources, locations, entity operations or processes, and entity continuity operations or processes (e.g., recovery or restoration operations or processes). In some embodiments, a separate database (e.g., a separate relational database that uses relational indexing) may be used to store the various data types described herein. In some embodiments, the at least one database may be stored in a housing that comprises the system described herein, or may be stored at a remote network location and may be accessible by the system described herein.

Additionally, in some embodiments, the system measures financial loss associated with an adverse scenario. Therefore, the system measures the financial loss associated with a particular resource/location pair that is adversely affected by occurrence of the adverse scenario. Additionally, the system measures the financial loss associated with one or more entity operations that are adversely affected by occurrence of the adverse scenario. Additionally, the system measures the cost associated with implementing one or more continuity operations to counter the adverse effects associated with occurrence of the adverse scenario. In some embodiments, the system adds or couples the various financial losses and costs described herein, and presents a total financial loss caused by occurrence of the adverse scenario.

In some embodiments, the system generates an entity process vulnerability calculation. The entity process vulnerability calculation may be based on the complexity of the entity (e.g., complexity associated with resources, locations, entity operations, etc.), the preparedness of the entity (e.g., the number of and/or type (and/or complexity) of entity continuity operations that are available), and the importance of at least one of the affected resources, the affected locations, the affected entity operations, etc. In some embodiments, each of the complexity, preparedness, and importance quantities may be standardized based on a predetermined scale. In some embodiments, the entity process vulnerability comprises subtracting the preparedness quantity from the complexity quantity to produce a resultant quantity, and multiplying the resultant quantity by the importance quantity.

Referring now to FIG. 1, FIG. 1 presents a user interface associated with the invention described herein. The user interface may be presented on any computing device. The user interface presents a scenario 110 selected by the user or selected automatically by the system described herein. Additionally, the user interface presents a brief description 115 of the selected scenario. Additionally, the user interface presents the resources 120 that are at least partially adversely affected by the adverse scenario. Additionally, the user interface presents the probability 125 associated with occurrence of the adverse scenario. Additionally, the user interface presents a percentage availability 130 associated with at least one continuity operation to at least partially restore the adversely affected resources. Additionally, the user interface presents a list of continuity operations 135 that are directed to at least partially restoring the adversely affected resources. Additionally, the user interface presents options to select a new threat scenario 180 and/or retrieve a saved threat scenario 190. Additionally, the user interface presents an option to cancel or delete a scenario 145. Additionally, the user interface presents an option to initiate an event 140. An event may be an adverse scenario, an entity operation, an entity continuity operation, or some other event, etc.

Additionally, the user interface presents the matrix of resources 160 versus locations 170 previously described herein. For a resource/location pair, an indicator 152 (e.g., a green-colored indicator) is presented that indicates a continuity operation is ready and/or available to at least partially counter the adverse effects caused by occurrence of the adverse scenario. If the continuity operation is not ready and/or not available to at least partially counter the adverse effects caused by occurrence of the adverse scenario, a different indicator 150 (e.g., a red-colored indicator) is presented. In some embodiments, for the resource/location pairs associated with red-colored indicators, the system initiates notification (e.g., notification regarding the affected resource/location pairs) to one or more other systems or personnel associated with the entity. In some embodiments, the resource/location pairs associated with red-colored indicators may be referred as gaps of the entity. They are referred to as gaps because these resource/location pairs are at least partially adversely affected by occurrence of the adverse scenario, and/or because a continuity operation is not ready and/or available to at least partially counter the adverse effects caused by occurrence of the adverse scenario. The user interface (e.g., the matrix) may or may not present the resource/location pairs that are not adversely affected by occurrence of the adverse scenario.

As indicated in FIG. 1, exemplary locations include an operations center, corporate headquarters, etc. Additionally, as indicated in FIG. 1, exemplary resources include documents and records, electronic data files, employees and contractors, facilities, mission critical applications, non-technology services, resident technologies, technology service providers, etc. Additionally, as indicated in FIG. 1, exemplary entity continuity operations include an inclement weather plan, an operations staffing shortage plan, an unavailable contractors plan, etc. As indicated in FIG. 1, the scale illustrates that the green-colored indicator stands for “Plan Ready” and the red-colored indicator stands for “No Plan Available.” As used herein, “plan ready” may mean that an entity continuity operation is available to substantially restore normal operation associated with an affected resource/location pair. As used herein, “no plan available” may mean that an entity continuity operation is not available to substantially restore normal operation associated with an affected resource/location pair.

In some embodiments, more than two indicators may be presented. In such embodiments, the system firstly determines whether a resource/location pair is at least partially adversely affected by occurrence of the adverse scenario and secondly determines whether at least one entity continuity operation is available to at least partially restore substantially normal operation associated with the affected resource/location pair (or to at least partially counter the adverse effects caused to the resource/location pair by occurrence of the adverse scenario).

If the answer to both the first and second determinations is ‘Yes,’ a first indicator (e.g., a green-colored indicator with a highlighted white ring 155 around the green-colored indicator) is presented for the resource/location pair. If the answer to the first determination is “No’ and the answer to the second determination is ‘No,’ a second indicator is presented for the resource/location pair (e.g., a red-colored indicator 150 without a highlighted white ring around the red-colored indicator). If the answer to the first determination is ‘No’ and the answer to the second determination is ‘Yes,’ a third indicator is presented for the resource/location pair (e.g., a green-colored indicator 152 without a highlighted white ring around the green-colored indicator). If the answer to the first determination is ‘Yes’ and the answer to the second determination is ‘No,’ a fourth indicator is presented for the resource/location pair (e.g., a red-colored indicator or red-colored indicator with a highlighted white ring around the red-colored indicator). The invention is limited to presenting color-based indicators. Other embodiments of the invention may incorporate other types of indicators (e.g., graphical indicators, visual indicators, aural indicators, etc.).

Additionally, in some embodiments, the shading of a colored indicator indicates the extent (e.g., the percentage) to which the resource/location pair has been adversely affected (e.g., the severity) and/or the extent (e.g., the percentage) of restoration that can be achieved by the entity continuity operation. For example, where an entity continuity operation is available for a resource/location pair, a bright-shaded green-colored indicator indicates that the resource/location pair has been minimally adversely affected by occurrence of an adverse scenario and/or that a high percentage of restoration can be achieved by the entity continuity operation, and a dark-shaded green-colored indicator indicates that the resource/location pair has been substantially adversely affected by occurrence of an adverse scenario and/or a low percentage of restoration can be achieved by the entity continuity operation. As a further example, where an entity continuity operation is not available for a resource/location pair, a dark-shaded red-colored indicator indicates that the resource/location pair has been minimally adversely affected by occurrence of an adverse scenario, and a bright-shaded red-colored indicator indicates that the resource/location pair has been substantially adversely affected by occurrence of an adverse scenario.

In some embodiments, the resource/location pairs are arranged in descending order from most affected resource/location pairs to least affected resource/location pairs. In other embodiments, the resource/location pairs are arranged in order from most restorable resource/location pair to least restorable resource/location pair, wherein whether a resource/location pair can be restored depends at least partially on the type, number of, and availability of continuity operations that are triggered to restore an affected resource/location pair. In still other embodiments, the resource/location pairs are arranged in order from affected resource/location pairs that incur the highest loss (e.g., financial loss, personnel loss, etc.) to affected resource/location pairs that incur the lowest loss. In some embodiments, the type and/or number of continuity operations that are triggered is based at least partially on the type of selected adverse scenario and/or the type of resource/location pairs that are at least partially affected by occurrence of the adverse scenario.

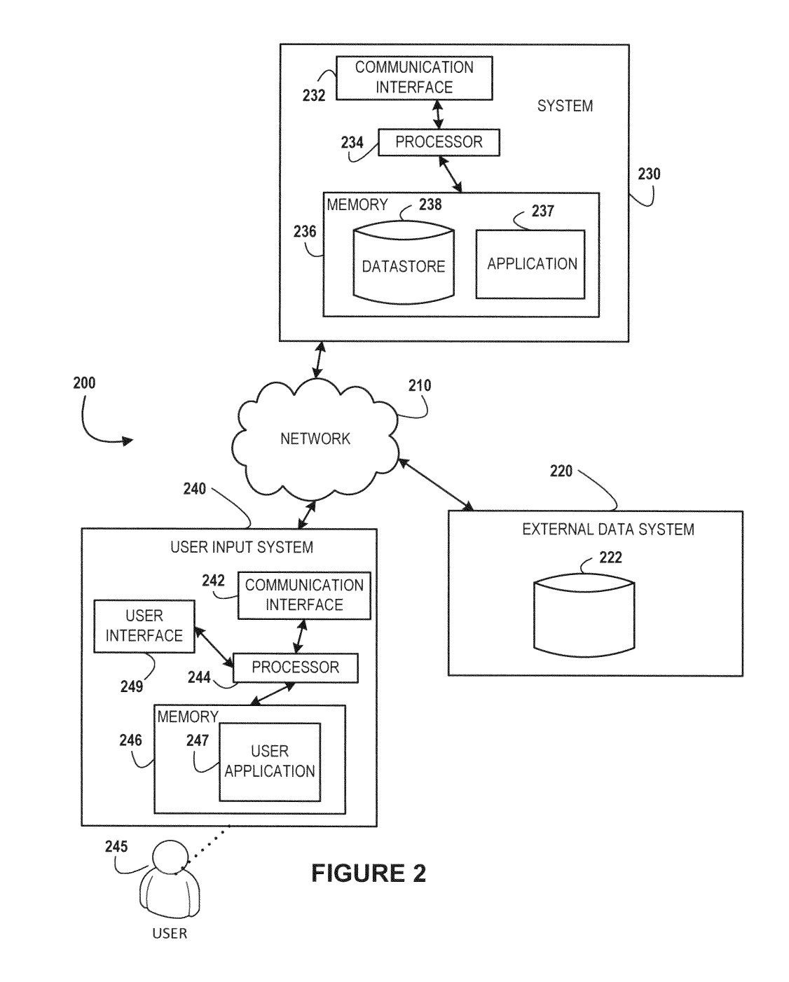

Referring now to FIG. 2, FIG. 2 presents an exemplary block diagram of the system environment 200, in accordance with embodiments of the present invention. As illustrated, the system environment 200 includes a network 210, an external data system 220, a system 230, and a user input system 240. Also shown in FIG. 2 is a user 245 of the user input system 240.

As shown in FIG. 2, the external data system 220, the system 230, and the user input system 240 are each operatively and selectively connected to the network 210, which may include one or more separate networks. In addition, the network 210 may include a local area network (LAN), a wide area network (WAN), and/or a global area network (GAN), such as the Internet. It will also be understood that the network 210 may be secure and/or unsecure and may also include wireless and/or wireline and/or optical interconnection technology.

The external data system 220 may be any computing or non-computing system that transmits data to the system 230. Additionally or alternatively, data from the system 230 may be transmitted to the external data system 220. As presented in FIG. 2, the external data system 220 comprises at least one datastore 222. The external data system 220 may comprise data regarding at least one of resources, locations, entity operations, or entity continuity operations.

The user input system 240 may include any computerized apparatus that can be configured to perform any one or more of the functions of the user input system 240 described and/or contemplated herein. For example, the user 245 may use the user input system 240 to select an adverse scenario. In some embodiments, for example, the user input system 240 may include a personal computer system, a mobile computing device, a personal digital assistant, a network device, and/or the like. As illustrated in FIG. 2, in accordance with some embodiments of the present invention, the user input system 240 includes a communication interface 242, a processor 244, a memory 246 having a user application 247 stored therein, and a user interface 249. In such embodiments, the communication interface 242 is operatively and selectively connected to the processor 244, which is operatively and selectively connected to the user interface 249 and the memory 246.

Each communication interface described herein, including the communication interface 242, generally includes hardware, and, in some instances, software, that enables the user input system 240, to transport, send, receive, and/or otherwise communicate information to and/or from the communication interface of one or more other systems on the network 210. For example, the communication interface 242 of the user input system 240 may include a modem, server, electrical connection, and/or other electronic device that operatively connects the user input system 240 to another system such as the system 230.

Each processor described herein, including the processor 244, generally includes circuitry for implementing the audio, visual, and/or logic functions of the user input system 240. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 247 of the memory 246 of the user input system 240.

Each memory device described herein, including the memory 246 for storing the user application 247 and other data, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 2, the memory 246 includes the user application 247. In some embodiments, the user application 247 includes an interface for communicating with, navigating, controlling, configuring, and/or using at least one of the system 230 or the user input system 240. In some embodiments, the user application 247 includes computer-executable program code portions for instructing the processor 244 to perform one or more of the functions of the user application 247 described and/or contemplated herein. In some embodiments, the user application 247 may include and/or use one or more network and/or system communication protocols.

Also shown in FIG. 2 is the user interface 249. In some embodiments, the user interface 249 includes one or more user output devices, such as a display and/or speaker, for presenting information to the user 245 and/or some other user. In some embodiments, the user interface 249 includes one or more user input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 245 and/or some other user. In some embodiments, the user interface 249 includes the input and display devices of a personal computer, such as a keyboard and monitor, which are operable to receive and display information.

FIG. 2 also illustrates a system 230, in accordance with an embodiment of the present invention. The system 230 may include any computerized apparatus that can be configured to perform any one or more of the functions of the system 230 described and/or contemplated herein. In accordance with some embodiments, for example, the system 230 may include a computer network, an engine, a platform, a server, a database system, a front end system, a back end system, a personal computer system, and/or the like. In some embodiments, such as the one illustrated in FIG. 2, the system 230 includes a communication interface 232, a processor 234, and a memory 236, which includes an application 237 and a datastore 238 stored therein. As shown, the communication interface 232 is operatively and selectively connected to the processor 234, which is operatively and selectively connected to the memory 236. The application 237 may perform functions associated with the system 230.

It will be understood that the application 237 may be configured to implement any one or more portions of process flow 400 described and/or contemplated herein. It will also be understood that, in some embodiments, the memory includes other applications. It will also be understood that, in some embodiments, the application 237 is configured to communicate with the datastore 238, the user input system 240 and/or the external data system 220.

It will be further understood that, in some embodiments, the application 237 includes computer-executable program code portions for instructing the processor 234 to perform any one or more of the functions of the application 237 described and/or contemplated herein. In some embodiments, the application 237 may include and/or use one or more network and/or system communication protocols.

In addition to the application 237, the memory 236 also includes the datastore 238. As used herein, the datastore 238 may be one or more distinct and/or remote datastores. In some embodiments, the datastore 238 is not located within the system and is instead located remotely from the system. In some embodiments, the datastore 238 stores information or data described herein. For example, the datastore 238 stores the list of resources, locations, entity operations, entity continuity operations, etc.

It will be understood that the datastore 238 may include any one or more storage devices, including, but not limited to, datastores, databases, and/or any of the other storage devices typically associated with a computer system. It will also be understood that the datastore 238 may store information in any known way, such as, for example, by using one or more computer codes and/or languages, alphanumeric character strings, data sets, figures, tables, charts, links, documents, and/or the like. Further, in some embodiments, the datastore 238 may include information associated with one or more applications, such as, for example, the application 237. It will also be understood that, in some embodiments, the datastore 238 provides a substantially real-time representation of the information stored therein, so that, for example, when the processor 234 accesses the datastore 238, the information stored therein is current or substantially current.

It will be understood that the embodiment of the system environment illustrated in FIG. 2 is exemplary and that other embodiments may vary. As another example, in some embodiments, the system 230 includes more, less, or different components. As another example, in some embodiments, some or all of the portions of the system environment 200 may be combined into a single portion. Likewise, in some embodiments, some or all of the portions of the system 230 may be separated into two or more distinct portions.

In addition, the various portions of the system environment 200 may be maintained for and/or by the same or separate parties. For example, the system 230 and the external data system 220 may be maintained by separate parties.

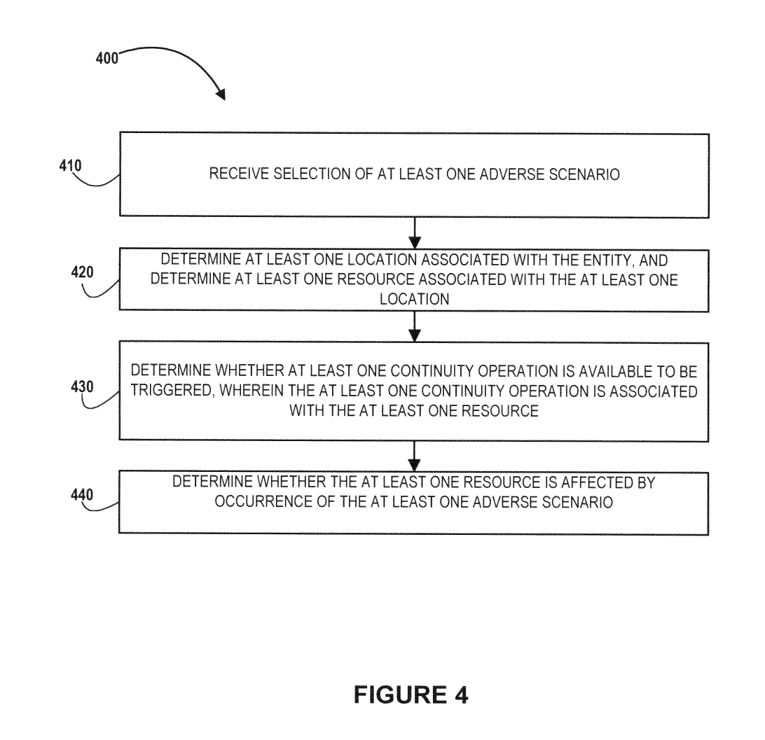

It will also be understood that the system 230 may include and/or implement any embodiment of the present invention described and/or contemplated herein. For example, in some embodiments, the system 230 (and/or the application 237) is configured to implement any one or more of the embodiments of the process flow 400 described and/or contemplated herein in connection with FIG. 4.

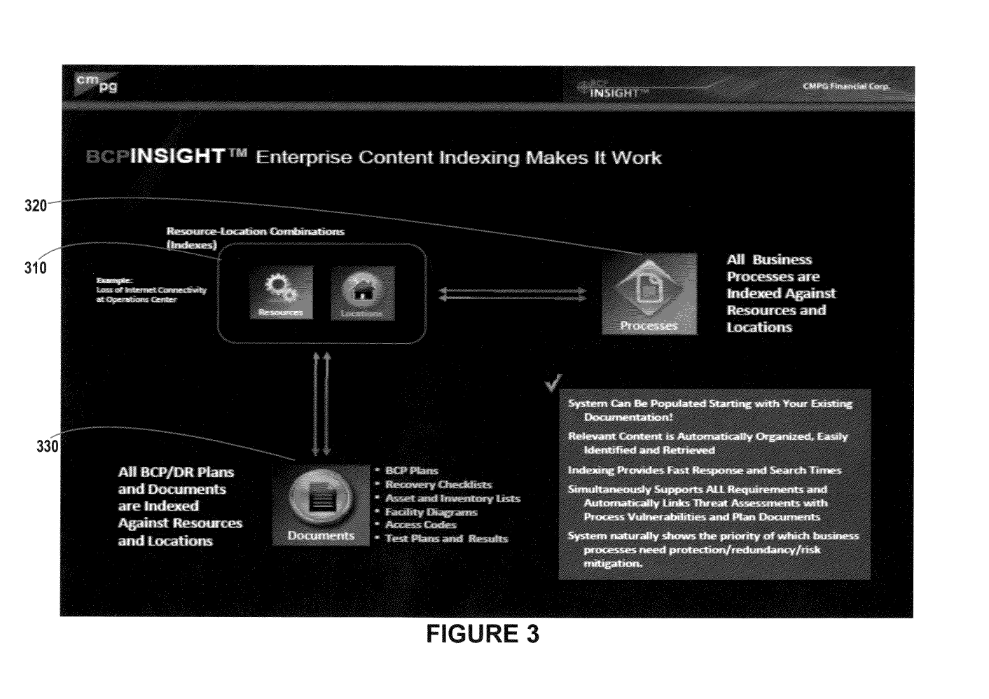

Referring now to FIG. 3, FIG. 3 presents a system block diagram that shows the entity operations are indexed against resource/location pairs and the continuity operations are also indexed against the resource/location pairs. As used herein, a resource/location pair may also be referred to as a resource/location combination or a resource/location node (or just simply a node). Therefore, the system described herein comprises at least one resources/location module 310, at least one entity operations module 320, and at least one entity continuity operations module 330. As indicated in FIG. 3, the system described herein can also be populated using an entity's existing documents, wherein the documents are associated with at least one of the resource/location pairs, the entity operations, or the entity continuity operations. The indexing described herein enables quick determination and retrieval of entity operations and/or entity continuity operations that are related to a resource/location pair. In some embodiments, the entity continuity operations are additionally indexed by at least one of an employee (a type of resource) or vendor (an organization or entity (e.g., a supplier, a distributor, etc.) that works with the entity that implements the system described herein).

In some embodiments, the type of indexing used herein is relational indexing. Therefore, at least one index may be stored as part of at least one of a database comprising resource/location pairs, a database comprising entity operations, a database comprising entity continuity operations, etc. In some embodiments, the index may be created based on functions or expressions, or conditional functions or expressions. Therefore, when an adverse scenario occurs and adversely affects at least one resource/location pair, the system described herein can access the index of the database comprising the entity operations to determine which entity operations are affected by executing a search using the affected resource/location pair as the search criteria. Additionally, the system described herein can access the index of the database comprising the entity continuity operations to determine which entity continuity operations are triggered by executing a search using the affected resource/location pair as the search criteria. The search may be executed using at least a partial portion of the string of characters that comprise the resource name and/or at least a partial portion of the string of characters that comprise the location name. The search described herein is executed so that each row or entry in the entity operations database or the entity continuity operations database does not need to be searched. In other embodiments, the database comprising the resources and/or locations may be search using an index associated with the database. The search may be executed using at least a partial portion of the string of characters that comprise an entity operation name and/or at least a partial portion of the string of characters that comprise an entity continuity operation name.

Referring now to FIG. 4, FIG. 4 is an exemplary process flow 400, in accordance with embodiments of the present invention. In some embodiments, the process flow may include less or more steps than those presented in FIG. 4. Additionally, the steps of the process flow may be performed in an order different from that presented in FIG. 4. At block 410, the process flow comprises receiving selection of at least one adverse scenario. At block 420, the process flow comprises determining at least one location associated with the entity, and determining at least one resource associated with the at least one location. At block 430, the process flow comprises determining whether at least one continuity operation is available to be triggered, wherein the at least one continuity operation is associated with the at least one resource. At block 440, the process flow comprises determining whether the at least one resource is at least partially affected by occurrence of the at least one adverse scenario.

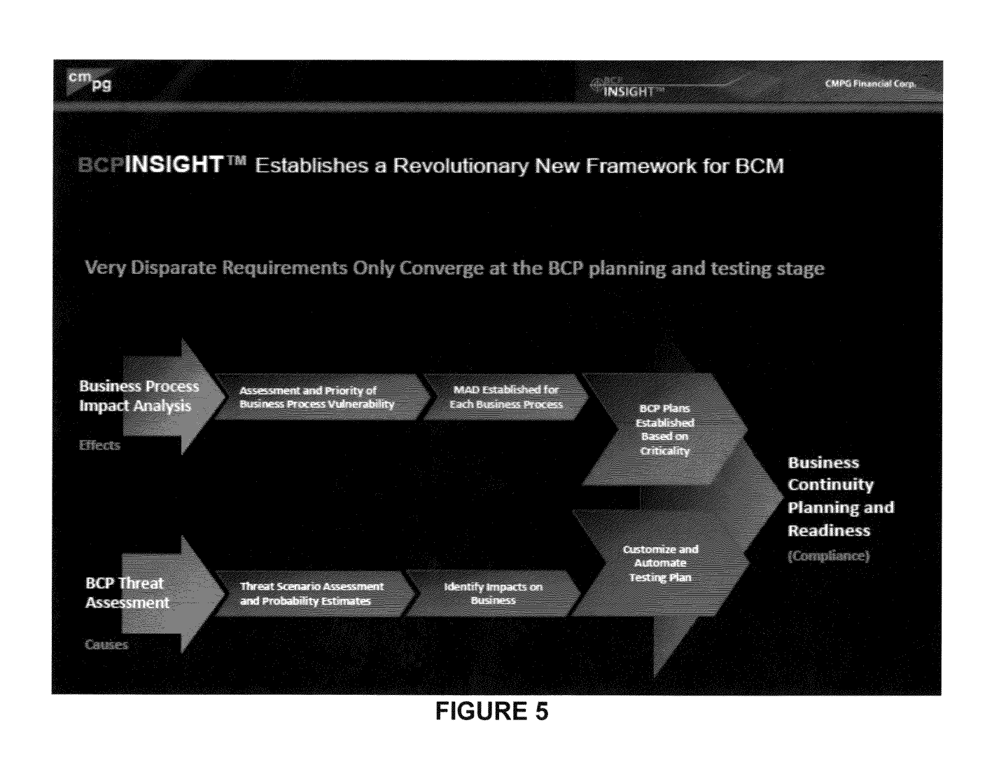

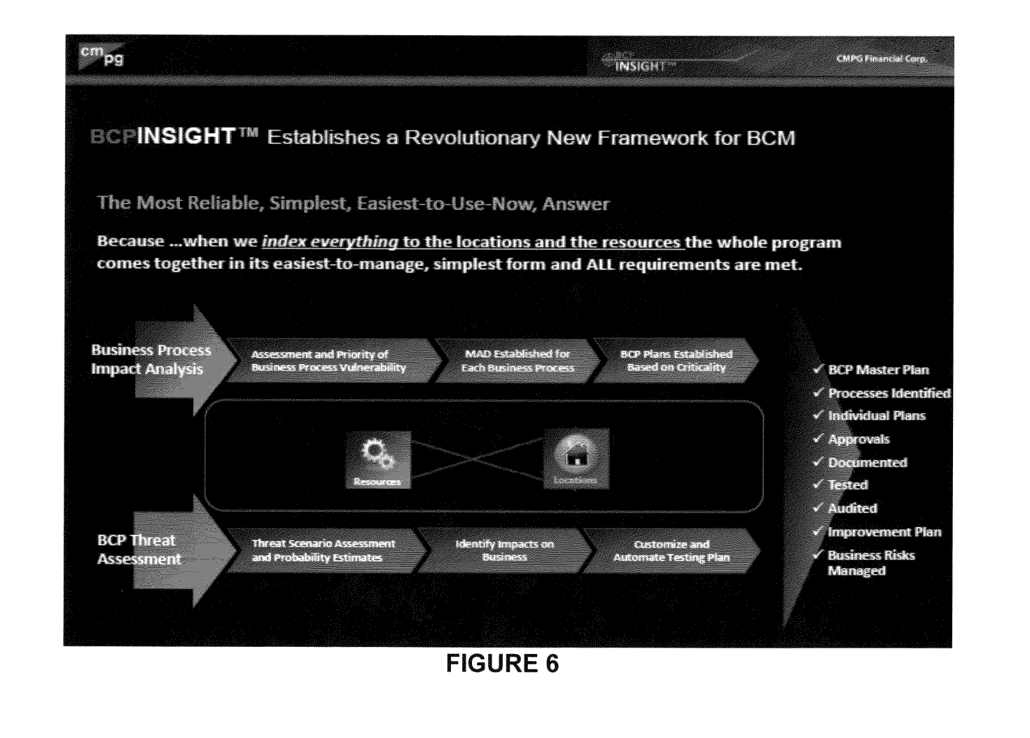

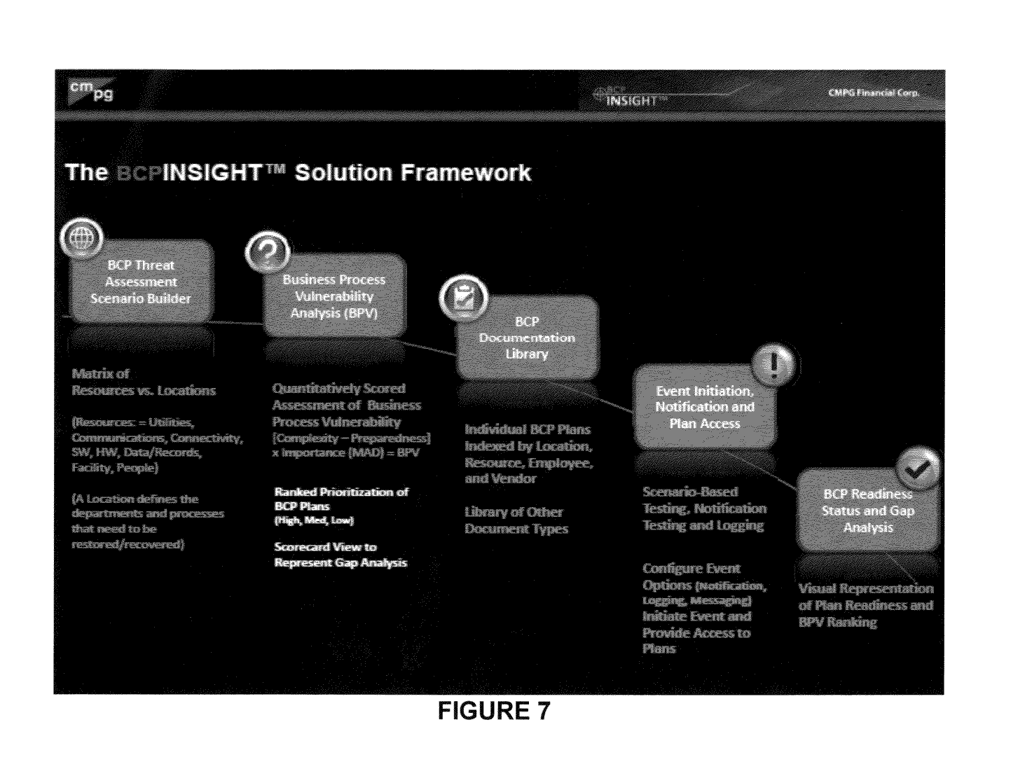

Referring now to FIGS. 5-7, FIGS. 5-7 present additional processes associated with the invention described herein.

In accordance with embodiments of the invention, the term “module” with respect to a system (or a device) may refer to a hardware component of the system, a software component of the system, or a component of the system that includes both hardware and software. As used herein, a module may include one or more modules, where each module may reside in separate pieces of hardware or software.

As used herein, the term “automatic” refers to a function, a process, a method, or any part thereof, which is executed by computer software upon occurrence of an event or a condition without intervention by a user.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for determining readiness of a computing network to operate under adverse conditions, the system comprising:
a computing network comprising a plurality of networked computing resources; and
a module stored in a memory, executable by a computing device processor and configured to:
receive selection of at least one adverse condition scenario that may affect the computing network,
determine at least one location within the computing network,
determine at least one of the computing resources associated with the at least one location,
determine whether at least one continuity operation is available to be triggered, wherein the at least one continuity operation is associated with the at least one of the computing resources, and
determine whether the at least one of the computing resource is affected by occurrence of the at least one adverse condition scenario.

2. The system of claim 1, wherein the module is further configured to perform at least one of:
in response to determining the at least one of the computing resources is adversely affected by occurrence of the at least one adverse scenario, initiate presentation of a first indicator on a user interface, or
in response to determining the at least one of the computing resources is not adversely affected by occurrence of the at least one adverse scenario, initiate presentation of a second indicator on the user interface.

3. The system of claim 1, wherein the module is further configured to:
initiate presentation of a matrix on the user interface, the matrix comprising the at least one of the computing resources, the at least one location within the computing network, and at least one indicator indicating whether the at least one of the computing resources is adversely affected by occurrence of the at least one adverse condition scenario.

4. The system of claim 1, wherein the module is further configured to:
in response to determining the at least one of the computing resources is adversely affected by occurrence of the at least one adverse condition scenario, determine whether the at least one continuity operation is triggered, wherein the at least one triggered continuity operation is directed to at least partially restoring the at least one of the computing resources adversely affected.

5. The system of claim 4, wherein the module is further configured to perform at least one of:
in response to determining the at least one triggered continuity operation at least partially restores or replaces the at least one of the computing resources adversely affected, initiate presentation of a third indicator on a user interface; or
in response to determining the at least one triggered continuity operation does not at least partially restore or replace the at least one of the computing resources adversely affected, initiate presentation of a fourth indicator on a user interface.

6. The system of claim 4, wherein the module is further configured to
determine a vulnerability quantity of the computing network based at least partially on: a first attribute associated with the at least one of the computing resources, and a second attribute associated with the at least one continuity operation.

7. The system of claim 1, wherein the module is further configured to:
index the at least one continuity operation against the at least one of the computing resources and the at least one location within the computing network, wherein the at least one continuity operation at least partially restores or replaces the at least one of the computing resources adversely affected by occurrence of the at least one adverse condition scenario.

8. The system of claim 7, wherein the at least one continuity operation comprises at least partially restoring the at least one of the computing resources adversely affected and enabling access to at least one document, the at least one document comprising at least one of a recovery checklist, an asset list, an inventory list, a facility diagram, an access code, a test plan, a test result, a user list, a recovery plan, contact information, a job description, a process flow chart, or a work instruction.

9. The system of claim 7, wherein the at least one continuity operation comprises multiple continuity operations, and wherein the module is further configured to prioritize the multiple continuity operations, wherein the prioritization is based on an order of occurrence of the multiple continuity operations.

10. The system of claim 1, wherein the module is further configured to:
index at least one computer network operation against the at least one of the computing resources and the at least one location within the computing network, wherein the at least one computer network operation is adversely affected by occurrence of the at least one adverse condition scenario.

11. The system of claim 1, wherein the module is further configured to:
determine the readiness of the computing network to continue at least one computing network operation based at least partially on determining whether the at least one of the computing resources is affected by occurrence of the at least one adverse condition scenario, wherein the at least one computing network operation is associated with the at least one of the computing resources.

12. The system of claim 1, wherein the module is further configured to assign a probability of occurrence to the at least one selected adverse condition scenario.

13. The system of claim 1, wherein the module is further configured to receive the selection of the at least one adverse condition scenario by one of (i) automatically and randomly by the module, or (ii) manually by a user of the module.

14. The system of claim 1, wherein the module is further configured to receive the selection of the at least one adverse condition scenario in response to determining occurrence of the at least one adverse condition scenario.

15. The system of claim 1, wherein the at least one of the computing resources comprises multiple ones of the computing resources, and wherein the module is further configured to prioritize the multiple ones of the computing resources adversely affected by occurrence of the at least one adverse condition scenario, wherein the prioritizing is based at least partially on at least one location within the computing network associated with each of the computing resources adversely affected by occurrence of the at least one adverse condition scenario.

16. The system of claim 1, wherein the at least one adverse condition scenario comprises at least one of a natural disaster, a man-made activity, a failure of the computing network, a loss of network connectivity, or a data loss.

17. A system for indexing within a computing network, the system comprising:
a computer network comprising a plurality of networked computing resources; and
a module stored in a memory, executable by a computing device processor and configured to:
determine at least one location within the computing network,
determine at least one of the computing resources associated with the at least one location within the computing network, and
index the at least one of the computing resources against the at least one location within the computing network.

18. The system of claim 18, wherein the module is further configured to:
determine at least one computer network operation or at least one continuity operation associated with the at least one of the computing resources; and
index the at least one computer network operation or at least one continuity operation against the at least one of the computing resources and the at least one location within the computing network,
wherein the at least one continuity operation at least partially restores or replaces the at least one of the computing resources when the at least one resource is at least partially adversely affected by occurrence of at least one adverse condition scenario.

19. The system of claim 17, wherein the module is further configured to:
receive selection of at least one adverse condition scenario; and
display an index on a user interface, wherein the index indicates at least one of whether at least one computer network operation or continuity operation is available for the at least one of the computing resources or whether the at least one of the computing resources is adversely affected by the at least one adverse condition scenario.
